(19) United States
(12) Patent Application Publication
(10) Pub. No.: US 2004/0101460 A1
(43) Pub. Date: May 27, 2004

(54) Apparatus and method for point-of-use treatment of effluent gas streams

(76) Inventors: Jose I. Arno, Brookfield, CT (US); Edward A. Sturm, Milford, CT (US); Joseph D. Sweeney, New Milford, CT (US)

Correspondence Address: ATMI, INC., 7 COMMERCE DRIVE, DANBURY, CT, 06810, US

(21) Appl. No.: 10/665,861

(22) Filed: Sep. 18, 2003

Related U.S. Application Data
(63) Continuation-in-part of application No. 09/212,107, filed on Dec. 15, 1998.
Application No. 09/212,107 is a continuation-in-part of application No. 09/086,033, filed on May 28, 1998.
Application No. 09/212,107 is a continuation-in-part of application No. 08/857,448, filed on May 16, 1997, now Pat. No. 5,935,283.

(51) Int. Cl. B01D 53/00; B01D 53/34

(52) U.S. Cl. 423/210; 423/240 R; 423/239.1; 422/171; 422/177; 422/186.3; 422/173; 422/180

(57) ABSTRACT

Multi-stage abatement systems and methods of use to remove final traces of pollutants and hazardous substances such as fluorinated species from effluents generated by semiconductor manufacturing operations. The effluent is treated in a main abatement tool, in combination with a secondary polishing scrubber that utilizes a high efficiency abatement technique to remove the final traces of pollutants from the effluent gas. The polishing scrubber can utilize treatment units such as high retention time scrubber vessels, recirculating post scrubber beds, dry post scrubbers, catalytic systems for OF₂ abatement, and/or UV radiation systems for OF₂ abatement.

### CROSS-REFERENCE TO RELATED APPLICATIONS

This is a continuation-in-part of U.S. patent application Ser. No. 09/212,107 filed Dec. 15, 1998 in the names of Jose I. Arno, et al. for “Apparatus and Method for Point-of-Use Treatment of Effluent Gas Streams,” which is a continuation-in-part of U.S. patent application Ser. No. 09/086,033 filed May 28, 1998 in the name of Jose I. Arno for “Apparatus and Method for Point-of-Use Abatement of Fluorocompounds,” and a continuation-in-part of U.S. patent application Ser. No. 08/857,448 filed May 16, 1997 in the names of Joseph D. Sweeney, et al. for “Clog-Resistant Entry Structure for Introducing Particulate Solids-Containing and/or Solids-Forming Gas Stream to a Gas Processing System,” issued Aug. 10, 1999 as U.S. Pat. No. 5,935,283.

### BACKGROUND OF THE INVENTION

1. Field of the Invention

This invention relates generally to post scrubbing systems and methods of use to remove final traces of pollutants and hazardous substances from effluents generated by semiconductor manufacturing operations.

2. Description of the Related Art

During recent years there has been an increased awareness of the short and long-term environmental impact of chemical processes, especially those associated with the semiconductor industry. Mandates have been established to push towards zero level release of greenhouse gases such as perfluorinated compounds (PFCs) and other environmentally harmful waste products, such as fluorine gas and other fluorinated organic gases.

In December 1997, over 160 countries negotiated the Kyoto Climate Protection Protocol. This global agreement was intended to encourage immediate efforts to reduce the emission of greenhouse gases. Perfluorinated gases were listed among the six gases specifically targeted for reduction under the protocol. These fluorine-saturated species are among the strongest greenhouse gases with global warming potentials (GWPs), and have GWP values that are 3-4 orders of magnitude higher than CO₂. Moreover, they are extremely stable molecules, with lifetimes of thousands of years in the atmosphere.

The electronics industry uses PFCs in a number of plasma processes to generate highly reactive F₂ and fluorine radicals. These in situ generated species are produced to remove residue from process tools and/or to etch thin films. The most commonly used PFCs include CF₄, C₂F₆, SF₆, C₃F₈, and NF₃. Notably, chamber cleans after chemical vapor deposition (CVD) processes account for 60-95% of current PFC use.

High PFC conversions inevitably result in the formation of hazardous air pollutants (HAPs). Breakdown products include mostly fluorine (F₂) and silicon tetrafluoride (SiF₄) gases and, to a lesser extent, HF and COF₂. Destruction of fully fluorinated gases generates considerably augmented HAP yields compared to the initial PFC volumes delivered to the tool.

By way of specific example, assuming stoichiometric conversion of PFCs into F₂, a 1-standard liter per minute (slpm) flow rate of NF₃ can potentially produce 1.5 slpm of F₂. The combined exhaust stream of four chambers could potentially generate up to 6 slpm of fluorine gas, resulting in a post-pump effluent concentration of 3% F₂ (50 slpm ballast N₂ per pump). These estimated worst case scenario values double with hexafluorinated PFCs (as compared to NF₃) and are likely to increase in the future with the projected throughputs of 300 mm wafer manufacturing.

The toxic and corrosive nature of fluorinated HAPs poses considerable health and environmental hazards in addition to jeopardizing the integrity of exhaust systems. In particular, the oxidizing power of F₂ is unmatched by any other compound and F₂ is far more reactive than other halogens. The large volumes of F₂ and other fluorinated hazardous inorganic gases released during optimized plasma processing require the use of abatement systems in order to minimize potential dangers and to prolong tool operation. At high concentrations, fluorine reacts exothermically with all elements except O₂, N₂, and noble gases. Consequently, a reasonable approach to F₂ abatement is to remove this highly active gas using naturally occurring reactions.

The main challenge to abatement is to produce innocuous solids or benign gases with preferably 100% efficiency. However, often times, there are small but detectable levels of hazardous gases that can escape from the abatement tool or small amounts of reacted process gases are converted into other potentially harmful substances. Representative abatement systems currently in use to abate fluorine-containing compounds include wet scrubbing, dry scrubbing, plasma dissociation, thermal degradation, flame oxidation/destruction, photo decay, etc.

Thermal abatement units combine reactive materials and F₂ inside a reactor heated using fuel, electrical energy or other energy source. The by-products generated by the thermal abatement of F₂ typically include hot acids that require the use of a post-thermal treatment water scrubber. However, the removal efficiencies in these post scrubber beds are often compromised since the scrubbing efficiency of most acid gases decreases as a function of temperature, and by-products or hazardous gases are still detectable.

In wet scrubbing systems used to abate F₂, fluorine gas reacts quickly and efficiently with H₂O. The main products of the reaction between water and F₂ are HF, O₂, H₂O₂, and the unwanted formation of OF₂. A further disadvantage is the large amount of water consumption that is necessary to achieve acceptable removal efficiencies at high fluorine challenges. Thus, the main disadvantages of a water scrubber are the high volumes of unwanted wastewater and production of undesirable byproducts.

Dry beds filled with a suitable dry chemical are also utilized to convert F₂ into innocuous solids or benign gases without generating excessive heat. However, dry scrubber are costly to use especially for applications with large target gas loads. Notably, whether a wet or dry scrubbing system is used for abatement, the abatement processes are not 100% effective, especially when these scrubbers are employed to service large volumes of effluents.

Thus, it would therefore be a significant advance in the art to provide effective abatement systems for abatement of fluorine or fluorine-containing compounds that are essentially 100% effective, thereby releasing only air and inert gases into the environment.

### SUMMARY OF THE INVENTION

The present invention relates generally to effluent abatement systems and processes for removing essentially all of any hazardous and unwanted gases with a polishing scrubber in combination with the main abatement tool.

In one aspect, the present invention relates to an effluent abatement system comprising a polishing scrubber communicatively connected to a main abatement system, wherein the polishing scrubber utilizes a high efficiency abatement technique to remove the final traces of pollutants from an effluent gas. Advantageously, materials or techniques that may have little or no utility in full process effluent treatment can be utilized for a final cleaning of the gas exhaust.

In another aspect, the present invention relates to a system for abatement of effluent including one or more contaminant(s), such as fluorine-containing species, F₂, ammonia, and/or silane, in which the system includes a main abatement tool for abating the effluent and a compact polishing scrubber for removal of any remaining contaminants in the effluent discharged from the main abatement tool, wherein the polishing scrubber includes one or more compatible features selected from the group consisting of:

(A) a water scrubbing system wherein the effluent includes ammonia and one or more fluorine-containing species, comprising a sump for collection of aqueous scrubbing medium, and the water scrubber being constructed and arranged to recirculate the aqueous scrubbing medium and provide a residence time of the aqueous scrubbing medium that is sufficient to solubilize sufficient ammonia to form ammonium hydroxide in sufficient amount to substantially remove fluorine-containing species from the effluent without forming OF₂;

(B) a recirculating polishing scrubber constructed and arranged to recirculate an ancillary scrubbing medium in a closed loop for contacting of the scrubbed effluent, to remove residual gases unabated by the main abatement tool and to destroy unwanted by-product fluorine-containing species in the scrubbed effluent;

(C) a polishing scrubber including a dry scrubber medium effective for removing OF₂ in contact therewith, wherein the dry polishing scrubber is constructed and arranged to contact said scrubbed effluent with the dry scrubber medium, to substantially remove OF₂ from the scrubbed effluent;

(D) a catalytic decomposition system including a catalyst medium effective to catalytically enhance decomposition of OF₂ in contact therewith, wherein the catalytic decomposition system is constructed and arranged to contact the scrubbed effluent with the catalyst medium, to catalytically decompose and substantially remove OF₂ from the scrubbed effluent; and

(E) an ultraviolet radiation decomposition system including an ultraviolet radiation source arranged to emit ultraviolet radiation effective for decomposition of OF₂ in exposure thereto, wherein the ultraviolet radiation decomposition system is constructed and arranged to expose the scrubbed effluent to said ultraviolet radiation from the ultraviolet radiation source, to decompose and substantially remove OF₂ from the scrubbed effluent.

Representative main abatement tools may include techniques for wet scrubbing, dry scrubbing, plasma dissociation, thermal degradation, flame oxidation/destruction, photo decay, etc. Preferably, the two-stage abatement systems of the present invention comprise a polishing scrubbing container that has a smaller diameter and/or volume containment relative to the main abatement tool. The smaller diameter and/or interior volume of the polishing scrubber in an embodiment that comprising a scrubbing medium enables proper wetting of the effluent with a much lower flow rate as compared to the main first stage column. In the case where the main unit is a water scrubber, the polisher actually will help to enable water scrubber to use very low levels of fresh water; if the polisher was not present, low levels of target gases would be exhausted into the house exhaust system. To attain the same level of performance without the polisher, the water flow to the main scrubber unit would have to be turned up considerably, and even then may not do the same job as the combined units. Further, the two-stage abatement system allows the acceptance of a higher gas challenge while providing for higher efficiency in abatement relative to a single stage scrubber system.

In another aspect, the invention relates to a method for abatement of effluent including one or more contaminant, such as fluorine-containing species, F₂, ammonia, and/or silane. The method includes treating the effluent in a main abatement tool and subsequent treatment of the discharged treated effluent from the main abatement tool with one or more additional compatible steps selected from the group consisting of the following:

(A) scrubbing a previously treated effluent comprising ammonia and one or more fluorine-containing species with an aqueous scrubbing medium, collecting the aqueous scrubbing medium in a collection volume thereof, and recirculating the aqueous scrubbing medium from the collection volume to the scrubbing step, with a residence time of the aqueous scrubbing medium in the collection volume being maintained to solubilize sufficient ammonia to form ammonium hydroxide in sufficient amount to substantially remove the fluorine-containing species from the effluent without formation of OF₂;

(B) recirculating an ancillary scrubbing medium in closed loop contacting of the previously treated effluent, to remove residual gases unabated by previous treatment and to destroy unwanted by-product fluorine-containing species in the scrubbed effluent;

(C) contacting the previously treated effluent with a dry scrubber medium effective for removing OF₂ from said treated effluent; contacting the previously treated effluent with a dry scrubber medium removingly effective for OF₂ in contact therewith, to substantially remove OF₂ from said treated effluent;

(D) contacting the previously treated effluent with a catalyst medium effective to catalytically enhance decomposition of OF₂ in contact therewith, to catalytically decompose and substantially remove OF₂ from the treated effluent; and

(E) exposing the previously treated effluent to ultraviolet radiation effective for decomposition of OF₂ in exposure thereto, to decompose and substantially remove OF₂ from the treated effluent.

The respective embodiments (A), (B), (C), (D), and (E) are hereafter sometimes referred to in the aggregate as “embodiments (A) to (E).”

Other aspects, features and embodiments of the invention therefore are more fully shown hereinafter, and will be more fully apparent from the ensuing disclosure and appended claims.

### BRIEF DESCRIPTION OF THE DRAWINGS

FIG. 1 is a schematic representation of a two-stage scrubber system according to the present invention.

FIG. 2 is a schematic representation of a polishing scrubber of the present invention for recirculating a fixed volume of fluid inside a packed bed, as installed at the exhaust of a main abatement tool to remove residual gases left unabated by the main abatement tool to destroy unwanted by-products such as OF₂.

FIG. 3 is a graph of destruction removal efficiency (% DRE) of oxygen difluoride (OF₂), as a function of time, for contacting of an OF₂-containing effluent with a carbon sorbent material having sorptive affinity for the oxygen difluoride in the effluent.

FIG. 4 is a graph illustrating Oxidation/Reduction Potential changes and OF₂ formation comparison between NaOH and NH₄OH solutions.

FIG. 5 is a graph illustrating measurement results for the formation of N₂ by the reaction between F₂/Ar and aqueous NH₄OH solution.

FIG. 6 is a schematic representation of a two-stage scrubber system according to one embodiment of the present invention.

FIG. 7 is a graph of improvement factor (decrease in ammonia exhaust concentration when a second-stage scrubber is employed, relative to a conventional single-stage scrubber) as a function of water flow rate, and various ammonia flow rates.

### DETAILED DESCRIPTION OF THE INVENTION AND PREFERRED EMBODIMENTS THEREOF

The disclosures of the following United States patent applications are hereby incorporated herein by reference in their respective entireties:

U.S. patent application Ser. No. 09/212,107 filed Dec. 15, 1998 in the name of Jose I. Arno, et al. for “Apparatus and Method for Point-of-Use Treatment of Effluent Gas Streams”;

U.S. patent application Ser. No. 09/086,033 filed May 28, 1998 in the name of Jose I. Arno for “Apparatus and Method for Point-of-Use Abatement of Fluorocompounds”;

U.S. Pat. No. 5,935,283 issued Aug. 10, 1999 in the names of Joseph D. Sweeney, et al. for “Clog-Resistant Entry Structure for Introducing a Particulate Solids-Containing and/or Solids-Forming Stream to a Fluid Processing System;” and

U.S. Pat. No. 5,846,275 filed Dec. 8, 1998 in the names of Scott Lane, et al. for “Clog-Resistant Entry Structure for Introducing a Particulate Solids-Containing Stream to a Fluid Processing System.”

The present invention in one aspect contemplates a two stage effluent abatement system comprising a main abatement tool for initial treatment of effluent and a subsequent polishing scrubber positioned for receiving discharged partially treated effluent from the main abatement tool for final removal of environmental contaminant, wherein the main abatement tool and/or the polishing scrubber may selectively comprise one or more compatible features of embodiments (A) to (E) for effluent treatment in accordance with the present invention, and various permutations and combinations of such treatment modalities are possible and efficacious for the abatement of effluent contaminants including: wet scrubbing+wet scrubbing, dry scrubbing, thermal scrubbing, or plasma abatement; dry scrubbing+wet scrubbing, thermal scrubbing, or plasma abatement; condensation plus dry scrubbing, thermal scrubbing, or plasma abatement; etc.

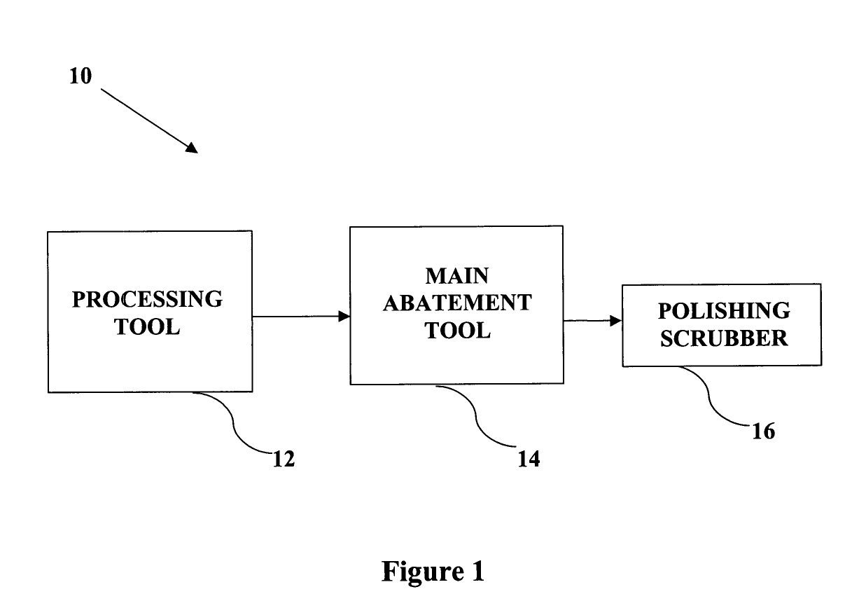

As shown in FIG. 1, the two-stage abatement system 10 communicatively connected to receive effluent from a processing tool 12 and which comprises a main abatement tool 14 that may be adapted for an abatement process that includes wet scrubbing, dry scrubbing, plasma dissociation, thermal degradation, flame oxidation/destruction, photo decay, and any of the processes described in embodiments (A) to (E). The polishing scrubber 16 positioned adjacent to the main abatement tool is sized to received the effluent discharged from the main abatement tool and having a flow through volume smaller than the main abatement tool and may comprise any of the processes described in embodiments (A) to (E).

The two-stage scrubber system of the present invention is highly advantageous for particulate and deposition elimination in the treatment of the effluent gas stream. The main abatement tool accommodates a large volume of effluent and preferably has a “wide-open” barrel confirmation, to provide effective scrubbing performance. In contrast, the polishing scrubber preferably has a relatively much smaller diameter and accommodates a relatively lower volume flow. Preferably, a polishing unit is less than 50% the size of the main scrubbing unit, and more preferably less than about 35% of the main scrubbing unit. The most preferred size has a total volume from about 100 cc to about 45,000 cc.

The removal efficiency of the two-stage abatement system of the present invention for removal of a given gas species will depend on its flow rate, which can be readily determined without undue experimentation by varying the respective flow rates and determining the rate and extent of removal, to determine the gas and scrubbing liquid flow rates that will provide the desired efficiency.

From the main abatement tool, the partially treated effluent flows to a polishing scrubber wherein the concentration of the undesired component(s) is further lowered. This so-called “polishing” scrubber may be a vertical column or a horizontal bed of any geometric shape, and as stated herein above has a volume smaller than the main abatement tool.

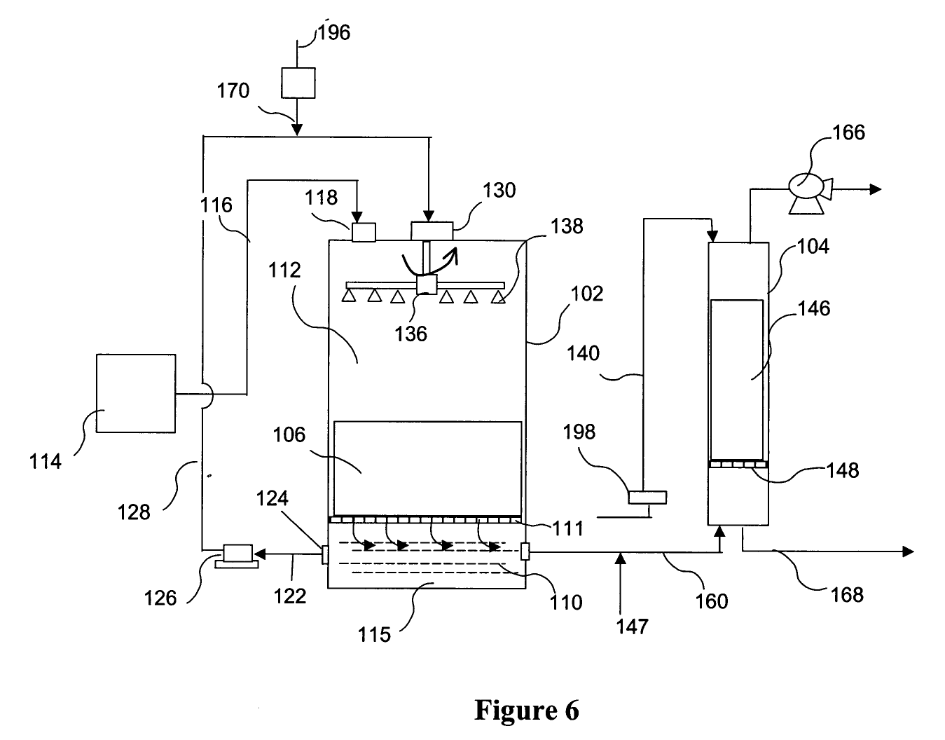

The two-stage scrubber system 100 shown in FIG. 6 is highly advantageous for particulate and deposition elimination in the treatment of the effluent gas stream. The first abatement column 102 has a large water flow rate and a “wide-opened” barrel confirmation, to provide effective washing performance in the gas scrubbing operation. A polishing column 104 has a relatively much smaller diameter and relatively substantially lower water flow rate, which by itself would normally be highly susceptible to clogging, but which in the two-stage scrubber system of the invention is protected by the upstream equilibrium column.

The two-stage scrubber system of the invention includes a first scrubber stage in which effluent gas is flowed cocurrently through the column with the scrubbing medium, e.g., in a downward direction. The first column may further comprise a packing liner 106. Slightly above the packed column a recirculating means 108 such as a rotating spray hub may be provided, whereby water from the sump at the bottom of the scrubber 110 is recirculated at a very high rate. This column serves to remove a large portion of the acid gases and also removes many of the solids that are either present in the incoming gas stream or are formed due to reaction of incoming gases with the water in the scrubber.

The removal efficiency of the scrubber first stage for removal of a given gas species will depend on its flow rate and the make-up water flow rate, which can be readily determined without undue experimentation by varying the respective flow rates and determining the rate and extent of removal, to determine the gas and scrubbing liquid flow rates that will provide the desired efficiency for the scrubber first stage unit.

From the first stage scrubber unit, the partially treated gas flows to a second stage water scrubber where the concentration of the undesired component(s) is further lowered. This so-called “polishing” column 104 is a vertical column in which the gas passes through in a countercurrent fashion. This column is typically much smaller than the first stage column. The smaller column size enables proper wetting of the packing with a much lower water flow rate as compared to the first stage column. The required water flow rate is low enough so that fresh make-up water can be used for this purpose. The efficiency of the column is therefore quite good and allows the 2-stage scrubber system to operate without using chemical injection agents or large amounts of fresh water.

There are a few ways to examine the advantages resulting from the use of a 2-stage water scrubber as compared to a conventional single stage water scrubber. For a given make-up water flow rate, the 2-stage design will enable significantly higher scrubbing efficiencies. On the other hand, if a given efficiency is required, the 2-stage design allows for a significant reduction in the make-up water flow rate. Finally, the 2-stage arrangement allows the scrubber system to accept a higher gas challenge while maintaining the same efficiency and make-up water flow rate as compared to a single stage scrubber system.

In the 2-stage scrubber system, the second stage simultaneously enables an increase in scrubbing efficiency while using a smaller flow rate of make-up water compared to a single stage scrubber design. Use of the polishing scrubber can obviate the need for chemical injection agents that would typically be required in order to achieve the efficiency results that readily are accomplished in the 2-stage scrubber system.

In a representative comparison, of a prior art single-stage scrubber system, and a two-stage water scrubber system of the present invention, for scrubbing of fluorine gas, a nitrogen flow containing fluorine was treated by water scrubbing in the respective systems. The resulting performance data are shown in Table B below.

TABLE B

| | | | | |
|---|---|---|---|---|
| | | | | Equivalent |
| Make-up Water | Total N2 | | F2 inlet | Outlet(HF) |
| (GPM) | (slpm) | Chem inject? | (slpm) | (ppm) |

Single-Stage Water Scrubber

| | | | | |
|---|---|---|---|---|
| 1.2 | 80 | no | 0.5 | 10.5 |
| 1.2 | 80 | yes | 0.5 | 69.5 |
| 0.5 | 80 | yes | 3.0 | 745.5 |

Two-Stage Water Scrubber

| | | | | |
|---|---|---|---|---|
| 0.75 | 80 | no | 0.5 | 4.2 |
| 0.75 | 80 | no | 1.0 | 8.4 |
| 0.75 | 80 | yes | 2.25 | 2.5 |
| 0.75 | 230 | yes | 3.0 | 42.8 |
| 0.75 | 230 | yes | 5.0 | 98 |

The foregoing data show the improvement of fluorine abatement and low water consumption requirements of the claimed two-stage water scrubber system of the present invention.

The foregoing data show the improvement of fluorine abatement and low water consumption requirements of the two-stage water scrubber system.

In a specific embodiment, the first stage of the 2-stage scrubber system comprises a packed column with a diameter of 21″ and a height of 18″, through which semiconductor process tool exhaust gases pass in a cocurrent fashion. The second stage column has a diameter that is less than the first stage scrubber and preferably from about 0.5 to about 0.15 smaller than the diameter of the first stage scrubber. More preferably, the diameter is about 4″ and has a height of 18″, permitting a much lower water flow rate to be used for scrubbing as compared to the first stage column. This design is such that proper wetting of the packing can be achieved with a water flow rate of <0.5 GPM; fresh make-up water can therefore be used for this purpose.

In a specific embodiment, a novel column wall liner may be employed in the (second) polishing scrubber, which helps to increase the polishing scrubber's effectiveness. The liner also acts as a sock that contains the packing material of the polishing scrubber. Such design feature allows the polishing scrubber to be easily removed and replaced if cleaning is necessary. Additionally, the design allows the polishing scrubber to be easily retrofitted to existing Vector scrubbers in the field.

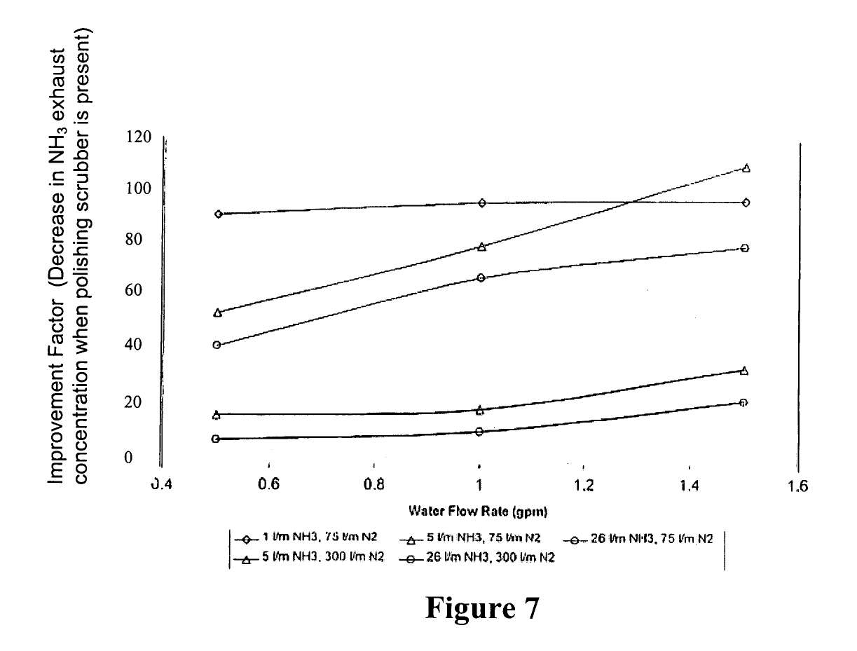

FIG. 7 is a graph of improvement factor for the decrease of ammonia exhaust concentration when the two-stage system with a polishing scrubber is used (in comparison to a corresponding system lacking the polishing scrubber), as a function of water flow rate, in gallons per minute. The graph shows that the polishing scrubber decreases the NH₃ outlet concentration up to 110 times (in relation to a corresponding scrubber system wherein no polishing scrubber is present) for a given make-up water flow rate. Additionally, the polishing scrubber can decrease the NH₃ outlet concentration up to a factor of 30 while using only ⅓ of the make-up water of a corresponding single stage scrubber system.

The 2-stage scrubber system comprises a first scrubber vessel 102 enclosing an interior volume which may contain a bed 106 of scrubber medium. The bed 106 may be provided as a removable insert forming a bed of packing material for gas/liquid contacting. The bag 106 is disposed on a support 111 which may comprise a grid, mesh, screen or other suitable foraminous member that is secured to the inner wall of the vessel 102 and is structurally strong enough to support the bed of packing material. It will be appreciated that the bed of packing material may be provided in an unbagged form, as a mass of the loose packing elements, as an alternative to the specific structure shown. Typically, the first scrubber vessel will in fact contain a bed of packing material without any liner or bag therefor.

Above the bed of packing material defined by the bag 106 is a head space 112 that receives the gas to be treated from the upstream process facility 114 such as a semiconductor processing plant, from which the effluent gas is flowed in line 116 to the scrubber vessel 102 and introduced into the interior volume of the vessel by an inlet device(s) The effluent gas feed line 116 is joined to the scrubber vessel 102 by fitting 118. In this manner the gas from the upstream facility is flowed downwardly through the bed of packing material, and is discharged from the scrubber vessel 102 into line 160.

The a sump area 110 is defined for collection of liquid scrubbing medium 115, e.g., an aqueous medium. From the sump 110, liquid is recirculated by means of line 122 joined to the wall of vessel 102 by fitting 124. Line 122 flows the scrubbing liquid to the pump 126, which discharges the liquid into recycle line 128, from which it is flowed into the drive module 130 which is drivingly coupled to hub 136 having arms equipped with spray nozzles 138 secured thereto. The drive module thus flows scrubbing liquid from line 128, augmented as necessary by make-up liquid from line 170 joined to a suitable source (not shown) of such liquid, to nozzles 138 for spray distribution over the bed of packing material in bag 106 (if included). The drive module concurrently rotates the nozzles connected to hub 136. Preferably, make-up water preferably will flow exclusively to the polishing column, because this provides the most optimal scrubbing potential; line 170 would contain the liquid discharge from the polishing scrubber 168 line that is recirculated.

The make-up liquid in line 170 may optionally be passed through a zone that comprises a pH adjustment zone, a lime-soda ash column for treatment (softening) of the scrubbing liquid, or a precipitation zone in which calcium is precipitated out of the scrubbing liquid by appropriate treatment thereof, so that the scrubbing liquid is depleted in calcium upstream of the scrubber chamber.

The liquid scrubbing medium thereby is flowed downwardly in the scrubbing vessel 102, in cocurrent flow relationship to the gas. In this manner, a large portion of the acid gases will be removed from the effluent gas being treated, and much of the solids in such gas will be concurrently removed by the scrubbing operation.

The effluent gas treated by scrubbing in the first scrubbing vessel 102 then is flowed in line 160 to the second scrubbing vessel 104. The second scrubbing vessel may include a bag 146 therein containing a packing material that may be supported on a support structure 148 that may be of a same or similar type to that used in the first scrubbing vessel.

Fresh scrubbing liquid is introduced to an upper portion of the scrubbing vessel 104 in line 140, which may be joined to a suitable source of scrubbing liquid (not shown). The scrubbing liquid may be distributed in the upper interior volume of the second scrubbing vessel by a distribution means such as that shown in connection with the first vessel, but the diameter of the second vessel generally is sufficiently small that a single spray head or nozzle is adequate for liquid introduction purposes, across the full transverse cross-section of the vessel.

The scrubbing liquid then flows downwardly through the packing in the bag 146 and is contacted with the gas introduced to the vessel 104 from line 160. The gas from line 160 thus is introduced in a lower portion of the vessel interior volume and flows upwardly through the packing material in bag 146 to effect intimate gas/liquid contacting for scrubbing of the gas.

The scrubbed gas thus passes to the upper portion of the interior volume of the vessel 104 and is discharged. The scrubbing liquid after passage through the bed of packing material is discharged from the lower portion of the vessel 104 in line 168, and may be further treated before final disposition, and/or recirculated in the system, e.g., as make-up flowed to line 170 for subsequent introduction into first scrubber vessel 102.

The 2-stage scrubbing system described above is highly advantageous in terms of minimizing the amount of clean water that is utilized in the scrubbing treatment of the gas. Further, the system involving multiple scrubbing steps obviates the need for chemical treatment, and thus achieves a significant advance in the art, in enabling efficient scrubbing treatment to be carried out without significant water requirements and without high operating costs that are otherwise associated with chemical usage.

It will be appreciated that although a 2-stage embodiment of the scrubbing system has been shown and described, other embodiments of the invention may be employed wherein more than one scrubbing vessel and associated scrubbing steps are provided.

Embodiment A: Low Flow Water Scrubber During Silicon Nitride Processes

Silicon nitride processes typically proceed in two steps: a deposition stage, followed by a chamber clean. During deposition, silane (SiH₄), ammonia (NH₃), and an oxidizing agent are combined in a plasma reactor. Ammonia utilization within the tool is typically low, resulting in large volumes of NH₃ sent to the exhaust and into the point-of-use or house scrubbers. The process further generates molecular fluorine and other fluorine-containing compounds.

In accordance with this embodiment of the present invention, the make-up water flow rate within the scrubber is reduced in order to accumulate significant volumes of NH₄OH in the sump deriving from ammonia in the effluent gas from the process tool. This effluent ammonia solubilizes in the aqueous scrubbing media, and in conventional practice is removed in the aqueous scrubbing medium as fresh make-up water is added to the scrubber water flow circuit. The present invention takes advantage of the solubilization of the ammonia in the aqueous scrubbing medium and departs from conventional practice by substantially increasing residence time of the aqueous scrubbing medium in the scrubber vessel, via increased retention of the sump liquid in the sump volume of the scrubber vessel. For example, a typical process continuously flows between about 2 slpm to about 8 slpm of ammonia, and more preferably about 4 slpm for about 30 minutes to about 60 minutes. Typical ammonia utilization rate in the tool is only about 25%, therefore between about 0.5 slpm to about 6 slpm are sent to the abatement device, and a total of between 15 liters to about 360 liters in a 30 to 60 minutes period. The sump of the water scrubber may contain about 60 liters of water and during operation, most of that water is recirculated while a small amount of fresh water is continuously introduced, for example about 1 to 1.5 liters per minute and drained out.

Taking these parameters into consideration, at the end of an approximately 45 minute period with an average of 3 slpm introduced into the scrubber, 93.9 gr. of ammonia will be collected in the sump of the scrubber in the form of ammonium hydroxide. This value equates to an ammonia concentration in the sump of 0.0016% by weight.

When the two-stage abatement system is used during a chamber cleaning, the aqueous NH₄OH collected in the sump is sufficient to remove F₂ without generating OF₂. In this manner, the process ammonia gas is retained or recycled in the sump for recycling and further use during the next chamber cleaning process. This re-use approach obviates the need for external chemical injection. This approach has been demonstrated as highly effective, in which ammonium hydroxide acts as an efficient reducing agent and inhibits the formation of OF₂, as shown in Example 1 set forth below.

Embodiment B: Recirculating Scrubber Bed

In this embodiment, a small footprint polishing scrubber that recirculates a fixed volume of fluid inside a packed bed may be installed at the exhaust of the main abatement tool, such as a water scrubbing system. The polishing scrubber is positioned to remove residual gases left unabated by the main abatement tool and to destroy unwanted by-products such as OF₂. Because the volume of OF₂ and other hazardous species is small (compared to the volume at the inlet of the main abatement tool), it would take a long time for the recirculating fluid to be fully used or depleted. The polishing scrubber fluid serves as a consumable that is regularly replaced during preventative maintenance of the scrubber units in the abatement system.

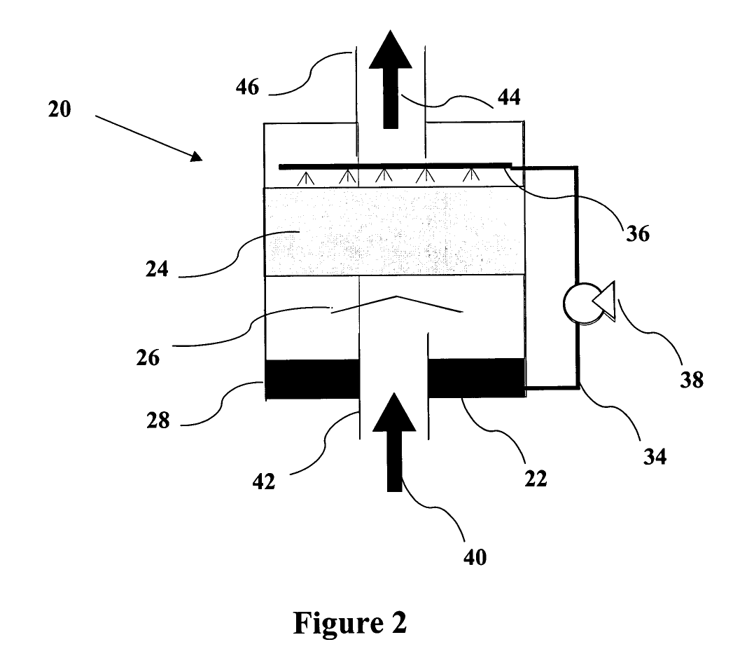

A schematic representation of such post scrubber 20 is shown in FIG. 2. The post scrubber 20 includes a housing 22 containing a packed bed 24 of suitable packing material, e.g., Pall rings, Raschig rings, saddles, helices, or other shaped packing elements of suitably size and type, which aggregately form a bed of the required character (as regards the void volume, bed diameter, surface-to-volume average of the packing elements, total surface area in the packed bed, etc.). The packed bed 24 is retained in position by suitable bed support structure, such as a grid, screen, mesh or other support or confinement structure.

In the interior volume of the housing 22 below the bed 24 is a water diverter 26, which serves to direct the downflowing recirculating, liquid (e.g., water) into the “mini” sump 28 in the interior volume of the housing. The mini sump 28 serves as an interior volume collection region for the recirculating liquid subsequent to its passage through the packed bed 24, from which the liquid is pumped by recirculating pump 38 in recirculation line 34 to the manifold 36 overlying the packed bed 24. The manifold 36 includes a plurality of nozzles as shown, which serve to distribute the recirculating liquid over the full cross-sectional area of the packed bed, and thereby maximizes gas-liquid contacting in the bed.

The effluent gas 40 from the main scrubber is introduced to the interior volume of the post scrubber in inlet 42 and flows upwardly through the housing 22, passing through the packed bed therein, and contacting the recirculating liquid. The contacted effluent gas 44 disengages from the packed bed and flows into the plenum space of the interior volume of the housing above the packed bed, and flows out of the housing, through outlet 46.

The recirculating fluid can include a strong reducing agent (including sodium or ammonium thiosulfate, ammonium hydroxide, ammonium fluoride), or any liquid phase material capable of removing OF₂, including low vapor pressure organic fluids, and/or dissolved inorganic salts. It will be recognized that the recirculating post-scrubber can be used as a polishing scrubber to abate other species in addition to OF₂.

Typical OF₂ levels measured at the exhaust of the scrubbers are approximately from about 5 ppm to about 15 ppm in an overall carrier gas flow of 50 slpm to about 150 slpm. This values compute to about 2.1×10⁻⁵ to about 6.3×10⁻⁵ moles of OF₂ per minute. The recirculation of 2 gallons of a strong reducing agent of a concentration of 1 molar provides 4.2 moles of OF₂ removing material. Assuming the stoichiometry of the reaction between the OF₂/reactant is 1:1, the recirculating fluid will last from about 50,400 to about 151,200 minutes or about 35 days to 105 days. Considering that a typical tool only performs chamber cleans 50% of the total available time, the recirculating post scrubber fluid will last from about 70 days to about 210 days.

Embodiment C: Cold or Heated Dry-Packed Polishing Scrubber:

In this embodiment, a dry material is added to a polishing scrubber positioned at the exhaust of the main abatement tool, such as a water scrubber to treat the effluent gas stream by absorbing and reacting with residual OF₂ generated during a fluorine abatement process. This embodiment may be carried out in a number of variations, as described below. In order to achieve highest efficiency and/or to minimize issues relating to water vapor, some of these variants are advantageously operated at elevated temperature.

Activated Carbon

High surface area carbon is utilized in this embodiment for adsorbing and reacting F₂ and OF₂. The form of the carbon used in the practice of this embodiment may be in any suitable form, as for example in a structured (honeycomb) carbon form or carbon in bead form. A honeycomb structure is generally preferred due to the associated low pressure drop and greater open path for effluent flow therethrough, with reduced likelihood of clogging, relative to other forms of carbon.

In the use of the preferred form of the honeycomb carbon structure, over 98% removal of OF₂ was achieved for an extended period of time in water vapor saturated conditions. Optimum performance was achieved when the carbon was heated to elevated temperature on the order of about 120° C. Carbon beads were also unaffected by high moisture levels and resulted in high absorption of OF₂.

The carbon contacting step is preferably carried out under conditions serving to convert the toxic OF₂ into inert carbon fluorine polymer. Such conversion is readily empirically determinable as to the process conditions necessary therefor, by the expedient of varying the process conditions and empirically attempting to desorb the F₂-containing species from the carbon sorbent material, with an inability to remove the fluorine-containing species being indicative of chemisorption and permanent reaction of the fluorine with the carbon, forming the fluorine-carbon polymer.

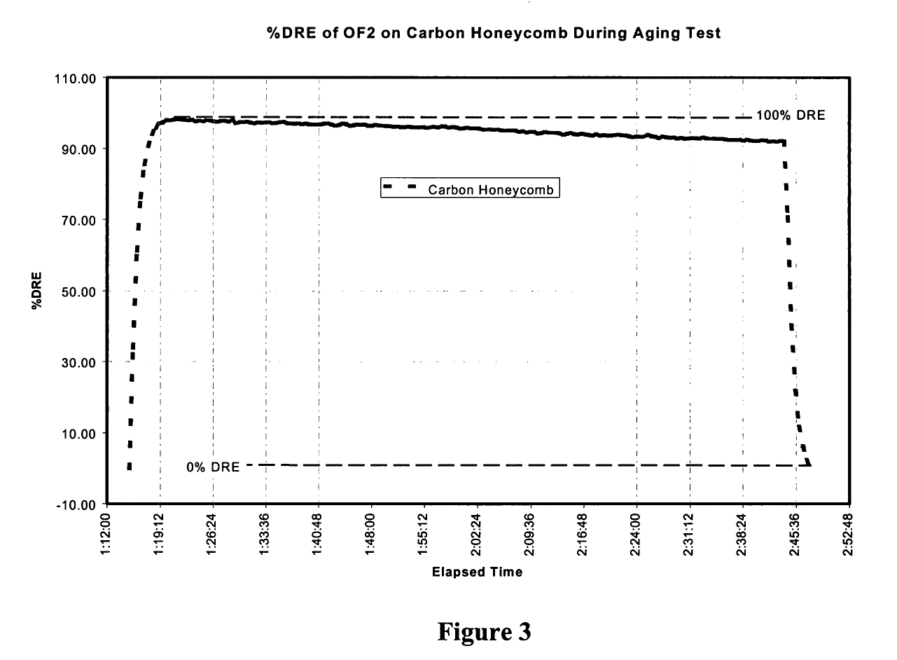

FIG. 3 shows the destruction removal efficiency (% DRE), as a function of time for the contact of oxygen difluoride in the fluorine-containing effluent with the carbon sorbent material and abated thereby (removed from the effluent stream). FIG. 3 depicts the time dependent results of switching the OF₂ carrying gas stream through a porous bed of carbon adsorbent material. In this example, the adsorbent carbon is a 2″ deep section of United Catalyst Activated Carbon Honeycomb Monolith obtained from SudChemie Prototech (Needham, Mass.). This carbon sample was selected for it's open physical structure and high surface area that result in low pressure drop across the bed but quick reactivity with the gas traveling through.

The plotted data represents one 90-minute pulse through the carbon bed (heated at 140° C.) starting at a time of 1 hour and 15 minutes into the generation and abatement of OF₂. The time scale on the X axis represents elapsed time in format of hh:mm:ss. This pulse begins at 01:15:00 and ends at 02:45:00. The gas stream is routed through an FTIR detector cell where OF₂ concentration is continuously monitored. The data shown represent the reduction in OF₂ content from the same gas flow bypassing the carbon bed (or destruction/removal efficiency) in units of percentage. Removal of all the OF₂ from the gas stream equals a DRE % of 100.

The results shown in FIG. 3 confirm the high removal (>90% DRE) achieved by the heated (140° C.) carbon sorbent, and demonstrate the efficacy of this embodiment of the invention for oxygen difluoride abatement.

Testing shows efficient removal of oxygen difluoride in the temperature range of room temperature (approximately 20° C.) to 200° C. (although higher temperatures would likely work as well). Preferably, in consideration of materials costs, the carbon is operated from about 120° C. to about 160° C., and more preferably, from about 125° C. to about 145° C. Above 100° C., less moisture accumulates on the carbon material than at lower temperatures, keeping more active surface area available to the flowing gas. Carbon bed size must be tailored to the specific system and gas flow regime, but preferably, it is desirable to have a gas residence time within the carbon bed of greater than or equal to 1 second (i.e. if gas linear velocity is 120 inches per minute, then a bed depth of 2 inches or more is recommended). For most abatement systems, it is desirable to keep pressure drop low and not impede gas flow greatly. For this purpose, desirable carbons are those of high porosity (open structure or low packing density; </=1 gram/cc) and high surface area (>/=250 cc/gram).

Heated Inorganic Materials

As an alternative to the use of carbon sorbent materials for oxygen difluoride abatement, the effluent stream including OF₂ and/or other fluorine-containing species may be contacted with other reactive inorganic materials at elevated temperature, such as S451D resin which is a calcium hydroxide based resin commercially available from W. R. Grace (Charlotte, N.C.).

Additional inorganic materials may be employed in this aspect of the invention, for contacting with fluorine-containing effluent streams to abate fluorine-species therein, at appropriate process conditions including elevated temperatures. For example, other hydroxide materials such as Ca(OH)₂, Cu(OH)₂, NaOH, Mg(OH)₂, LiOH, KOH, Ba(OH)₂, etc.; salts such as nitrates, carbonates, perchlorates of the simple 1A and 2A alkali metals (having larger atomic radii, low electronegativity, low ionization energy); or reducing agents such as sodium thiosulfate, ammonium hydroxide, potassium iodide, or finely divided metals such as iron, aluminum, magnesium, or zinc with affinity to react with OF₂ may be employed. The appertaining process conditions, including contacting temperatures, flow rates of effluent, etc. may be readily determined within the skill of the art, by empirical tests involving variation of the particular effluent stream process conditions and contacting bed parameters, e.g., bed size, void volume, bed temperature, etc., with measurement of the level of abatement of the specific fluorine-containing effluent species of interest for the different process conditions and variables selected.

Adsorbent abatement beds may be comprised of solid hydroxides, salt-coated alumina or silca oxides or zeolites, porous carbons, or active metal coated high surface area substrates (such as those used in catalyst applications).

Heated Metals

In this aspect of the invention, reaction of fluoro-species of the effluent with heated metals is utilized to effect abatement. The metal may be provided in a packed bed of the elemental metal, as disposed at the exhaust of the main abatement unit, or otherwise downstream from the abatement unit.

The metal in the packed bed may be in any suitable conformation, e.g., a form such as those mentioned illustratively hereinabove as packed bed structures, including beads, elongate structural forms, etc. Metals such as copper, aluminum, and/or iron may be employed for such purpose, as well as any other metal species that are reactive with fluorine containing species to form corresponding metal oxides, at the process conditions employed for contacting the metal packed bed. For such purpose, the elemental metal may be provided on a suitable support, or alternatively be provided as pure metal in appropriately divided forms.

The process conditions may be readily empirically determined within the skill of the art, by contacting the metal in the bed with an effluent composition containing a predetermined amount of fluoro-species, and measuring the effluent concentrations of such fluoro-species discharged from the contacting chamber, and varying the process conditions in successive runs, to determine the optimum or otherwise suitable conditions for carrying out the contacting of the F-containing effluent with the metal contact material.

By way of specific example, iron and copper may be usefully employed to remove fluorine-containing effluent species from effluent comprising same, by contact of the fluorine containing effluent with a bed of the elemental metal particles at temperatures on the order of approximately 300° C. Under such conditions of metal contacting, the Cu and Fe metals form the corresponding metal fluorides.

High surface area forms of the metals are preferred for such contacting, and appropriate high surface area forms of the metals may be readily determined by volumetric displacement tests, porosimetry measurements (when the metal is provided, for example, in the form of a sintered matrix or other porous form), and the like, to determine a best or otherwise appropriate form for use in a given application of such aspect of the invention.

Ideal candidate metals are finely divided or dispersed particles of active metals such as iron, aluminum, magnesium, zinc, tin, and silver which have good electron affinity and can be heated to temperatures in excess of 150° C. to facilitate electron mobility.

Embodiment D: Catalytic Decomposition of the Fluoro Species

In this embodiment of the invention, a catalyst material is positioned within a polishing scrubber to receive treated effluent from the main abatement tool thereby increasing the kinetics of the reaction responsible for the decomposition of OF₂.

Useful catalyst materials for this purpose include transition metals, which may be employed in pure metal forms, and/or in composite structures, e.g., involving catalytic transition metals deposited on or otherwise supported on suitable support materials or support elements.

By way of specific example, the transition metal catalyst may be mounted on honeycomb structures, for contacting with OF₂-containing effluent gas, to effect the decomposition of OF₂. The contacting of the F-containing effluent gas with the catalytic metal is desirably carried out at appropriate elevated temperature, as kinetically favorable to the decomposition reaction. Destruction of OF₂ is for example usefully carried out with transition metals such as platinum, palladium, rhodium, ruthenium, manganese, vanadium, molybdenum, iridium at temperatures on the order of 150-250° C.

Embodiment E: UV-Enhanced Decomposition

In this embodiment of the invention, ultraviolet (uv) radiation exposure of the treated effluent stream discharged from the main abatement unit to decompose OF₂.

UV radiation having a wavelengths ranging between 210 nm to 421 nm may be used in the present invention with optimum energy at about 365 nanometers (nm). Operating temperatures in a range between 15° C. to about 65° C. would be optimum for OF₂ decomposition.

The ultraviolet radiation is usefully supplied for such OF₂ abatement from any suitable UV source means, including for example a UV lamp emitting radiation of the desired spectral character effective for achieving decomposition of the OF₂ in exposure thereto, or a UV laser emitting UV light of the requisite character, UV down-converter or UV up-converter materials, which upon being exposed to radiation of higher or lower frequency are excited to responsively emit UV radiation of the desired character, spectral shifting devices for altering the frequency of incident radiation to a desired UV frequency, and/or any other suitable means for production of decompositionally effective (as regards OF₂) UV radiation. Suitable lasers may include a single frequency/laser such as the tunable laser UV-D-3 laser system by Opotek at www.opotek.com. Another UV source can be generated using narrow wavelength LED device such as the one developed by Uniroyal's Optoelectronic division POWER-Ga(i)N™ InGaN/Al2O3 device. A broad-band UV source can also be used. Many manufacturers of such lamps currently exist as the 365 nm wavelength that are used for curing applications. Light source intensities ranging between 0.1 and 5 W/cm² may be used for decomposition of OF₂.

This aspect of the invention may be carried out with serial or successive exposures of the effluent gas to differing wavelengths of ultraviolet radiation, as calculated to abate respective fluorine-containing species in the effluent containing multiple fluoro-species, wherein each of the respective fluoro-species is susceptible to abatement at a different optimal radiation wavelength.

The following example demonstrate the effectiveness of the treating effluent comprising fluorine species with ammonium hydroxide in the practice of the present invention.

### EXAMPLE 1

Previous tests involving the reaction of F₂ with a strong caustic solution (NaOH) resulted in significant volumes of OF₂ being formed. Consequently, it was expected that the fluorine gas reaction with a solution ammonium hydroxide would also result in the formation of oxygen difluoride. Unexpectedly and surprising it was found that OF₂ was not formed.

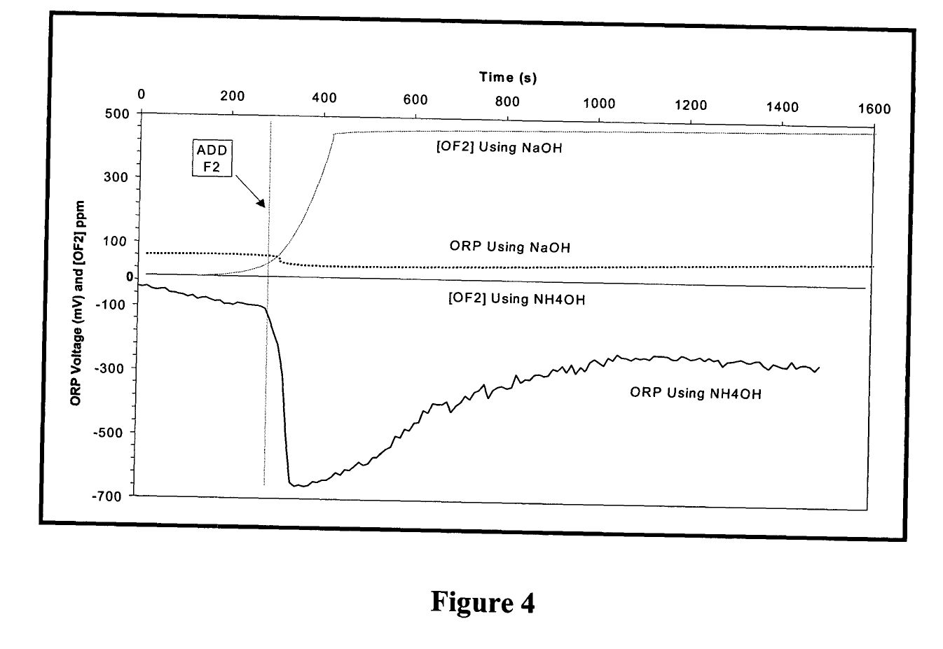

The setup used for these sets of experiments was the same for both the NaOH+F₂ study and NH₄OH+F₂. Different concentrations of 1 L solutions of ammonium hydroxide were prepared from a 5% NH₄OH solution. 15 sccm of F₂ mixed with 1 slpm N₂ where continuously bubbled through the aqueous solution while measuring the changes in gas-phase and liquid properties. FIG. 4 depicts the time dependent OF₂ concentration as a function of time from the reaction of F₂ with NaOH and NH₄OH solutions.

Both caustic solutions were prepared at a pH 11. The top portion of the graph represents NaOH results, while the bottom section to NH₄OH. As mentioned earlier, the first striking difference is that when using sodium hydroxide solution to neutralize F₂, 475 ppm OF₂ were formed compared to less than 1 ppm when using NH₄OH. The second significant distinction in FIG. 4 is the aqueous oxidation/reduction potential differences between the two solutions. Throughout the tests involving the sodium hydroxide solution, the ORP remained positive while the ORP measurements using NH₄OH were negative. The Ox-Red potential (ORP) is a measure of the ions and electrons present in solution. A positive ORP can be interpreted as lack of e⁻ in solution while a negative value defines excess electrons. In order for fluorine gas to decompose in water, it requires two electrons based on the reaction

F₂(g)+2e⁻→2F⁻ (1)

The strong oxidizing potential of fluorine forces many neighboring molecules to dissociate and release their internal electrons. This process is directly responsible for the positive ORP measurement found in water and NaOH solutions and indirectly the cause for the formation of OF₂. Ammonium hydroxide solutions are different because, upon interaction with F₂, they become a quick source of electrons. The magnitude and negative sign of the ORP measured when fluorine reacted with ammonium hydroxide corroborates this fact. The mild reducing reaction responsible for the supply of electrons was found to be:

2NH₄OH<N₂+2H⁺+2H₂O+6 e⁻E°/V=−0.092 (2)

The reduction potential voltage was found to be similar to the reduction reaction of thiosulfate.

2S₂O₃⁻²⇄S₄O₆⁻²+2 e⁻E°/V=−0.08 (3)

Sodium thiosulfate solutions were previously found to effectively inhibiting the formation of OF₂ when fluorine reacted with water.

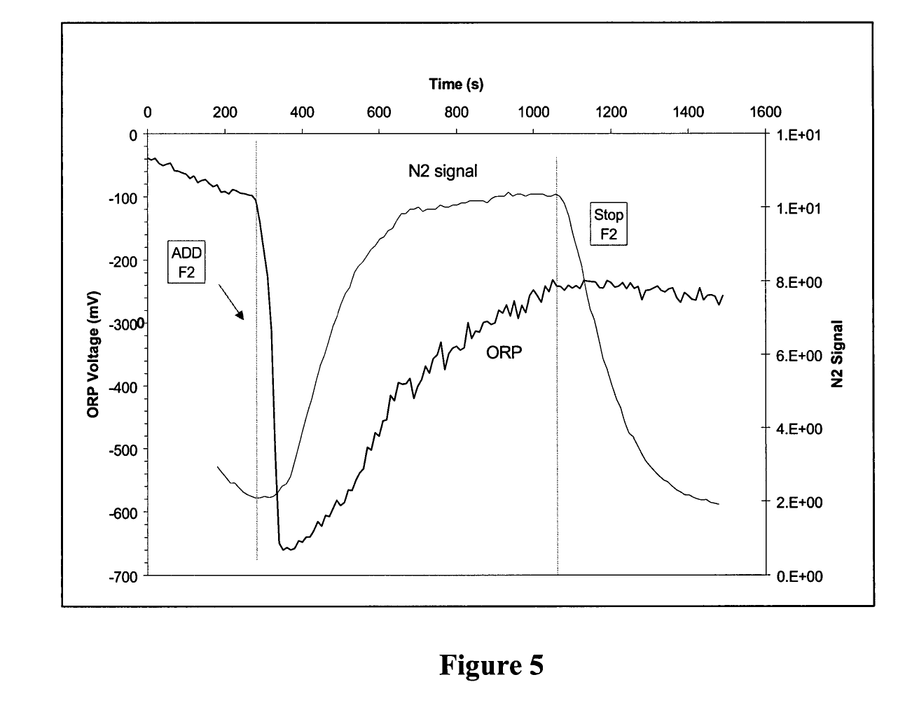

Further confirmation about the role of the NH₄OH dissociation in the fluorine reaction was achieved by the following experiment. A gas mixture of fluorine gas mixed with argon (instead of the usual N₂) was bubbled into the same reactor filled with an aqueous NH₄OH solution. The effluent gas stream was monitored using a residual gas analyzer in order to enable the measurement of any nitrogen gas being produced. The results of measured formation of N₂ by the reaction between F₂/Ar and aqueous NH₄OH solution are depicted in FIG. 5. Upon the addition of fluorine gas, the mass spectrometer detected nitrogen gas signal confirming the formation of molecular nitrogen consistent with reaction (2).

While the invention has been described herein with reference to specific embodiments and features, it will be appreciated the utility of the invention is not thus limited, but encompasses other variations, modifications, and alternative embodiments. The invention is, accordingly, to be broadly construed as comprehending all such alternative variations, modifications, and other embodiments within its spirit and scope, consistent with the following claims.

What is claimed is:

1. A system for abatement of effluent including one or more contaminant a main abatement tool and a polishing scrubber for removal of any remaining contaminants in the effluent discharged from the main abatement tool, wherein the polishing scrubber includes one or more compatible features selected from the group consisting of:
(A) a water scrubbing system wherein the effluent includes ammonia and one or more fluorine-containing species, comprising a sump for collection of aqueous scrubbing medium, and the water scrubber being constructed and arranged to recirculate the aqueous scrubbing medium and provide a residence time of the aqueous scrubbing medium that is sufficient to solubilize sufficient ammonia to form ammonium hydroxide in sufficient amount to substantially remove fluorine-containing species from the effluent without forming OF₂;
(B) a recirculating scrubber constructed and arranged to recirculate an ancillary scrubbing medium in a closed loop for contacting of the scrubbed effluent, to remove residual gases unabated by the main abatement tool and to destroy unwanted by-product fluorine-containing species in the scrubbed effluent;
(C) a scrubber comprising a dry scrubber medium effective for removing OF₂ in contact therewith, wherein the dry polishing scrubber is constructed and arranged to contact said scrubbed effluent with the dry scrubber medium, to substantially remove OF₂ from the scrubbed effluent;
(D) a catalytic decomposition system including a catalyst medium effective to catalytically enhance decomposition of OF₂ in contact therewith, wherein the catalytic decomposition system is constructed and arranged to contact the scrubbed effluent with the catalyst medium, to catalytically decompose and substantially remove OF₂ from the scrubbed effluent; and
(E) an ultraviolet radiation decomposition system including an ultraviolet radiation source arranged to emit ultraviolet radiation effective for decomposition of OF₂ in exposure thereto, wherein the ultraviolet radiation decomposition system is constructed and arranged to expose the scrubbed effluent to said ultraviolet radiation from the ultraviolet radiation source, to decompose and substantially remove OF₂ from the scrubbed effluent.

2. The system of claim 1, wherein the main abatement tool comprises a wet scrubbing system, a dry scrubbing system, a plasma dissociation system, a thermal degradation system, a flame oxidation/destruction system, or a photo decay system.

3. The system of claim 1, comprising the polishing scrubber of (A).

4. The system of claim 3, arranged in effluent-receiving relationship with a silicon nitride semiconductor process tool including a plasma reactor constructed and arranged for combination of silane, ammonia and an oxidizing agent during silicon nitride deposition, and for subsequent chamber clean of the plasma reactor generating molecular fluorine and other fluorine-containing compounds as effluent components.

5. The system of claim 3, wherein residence time of the aqueous scrubbing medium in the sump is in a range of from about 0.25 to about 10 minutes during said silicon nitride deposition.

6. The system of claim 3, wherein residence time of the aqueous scrubbing medium in the sump is sufficient to achieve a solubilization of ammonium hydroxide in a concentration range of from about 0.001 grams per liter to about 30 grams per liter.

7. The system of claim 1, comprising (B).

8. The system of claim 7, wherein the recirculating post scrubber comprises a vessel containing a packed bed of packing material facilitating gas/liquid contacting.

9. The system of claim 8, wherein the packed bed has a void volume in the range of from about 30% to about 70%, based on the total volume of the bed.

10. The system of claim 8, wherein the packed bed has an average surface to volume ratio of the packing elements in a range of from about 10,000 cm⁻¹ to about 100,000 cm⁻¹.

11. The system of claim 8, wherein the bed is confined in the vessel to a fixed spatial location.

12. The system of claim 8, wherein the ancillary scrubbing medium comprises a reducing agent.

13. The system of claim 12, wherein the reducing agent comprises a reducing agent selected from the group consisting of sodium thiosulfate, ammonium thiosulfate, ammonium hydroxide, ammonium fluoride, and combinations of two or more thereof.

14. The system of claim 8, wherein the ancillary scrubbing medium comprises a liquid phase material capable of removing OF₂ from the scrubbed effluent.

15. The system of claim 8, wherein the ancillary scrubbing medium comprises an organic fluid capable of removing OF₂ from the scrubbed effluent.

16. The system of claim 8, wherein the ancillary scrubbing medium comprises a dissolved inorganic salt capable of removing OF₂ from the scrubbed effluent.

17. The system of claim 1, comprising (C).

18. The system of claim 17, wherein the dry scrubber medium comprises carbon.

19. The system of claim 18, wherein the carbon comprises activated carbon.

20. The system of claim 18, wherein the carbon is in a bead form.

21. The system of claim 18, wherein the carbon is in a honeycomb form.

22. The system of claim 17, further comprising a heater for heating the dry scrubber medium to elevated temperature.

23. The system of claim 17, wherein the dry scrubber medium comprises a calcium hydroxide resin.

24. The system of claim 23, further comprising a heater for heating the dry scrubber medium to elevated temperature.

25. The system of claim 18, wherein the dry scrubber medium comprises a material reactive with OF₂ to abate same, selected from the group consisting of calcium hydroxide, copper hydroxide, sodium hydroxide, magnesium hydroxide, lithium hydroxide, potassium hydroxide, barium hydroxide and ammonium hydroxide.

26. The system of claim 17, wherein the dry scrubber medium comprises a bed of heated elemental metal reactive with fluorine-containing species in the effluent to abate same.

27. The system of claim 26, wherein the heated elemental metal comprises a metal selected from the group consisting of copper, aluminum and iron.

28. The system of claim 26, wherein the heated elemental metal comprises a metal disposed on a support in the post scrubber.

29. The system of claim 26, wherein the heated elemental metal comprises a metal in divided form, constituting a packed bed in the post scrubber.

30. The system of claim 26, further comprising means for maintaining the heated elemental metal at a sufficient temperature for the elemental metal to react with fluorine in the effluent to form a corresponding metal fluoride.

31. The system of claim 1, comprising (D).

32. The system of claim 31, wherein the catalyst medium comprises a transition metal.

33. The system of claim 32, wherein the transition metal is supported on a support element.

34. The system of claim 33, wherein the support element comprises a honeycomb structure.

35. The system of claim 32, wherein the transition metal is in an elemental metal form.

36. The system of claim 31, further comprising means for heating the catalyst medium to an elevated temperature sufficient to effect catalytic decomposition of OF₂.

37. The system of claim 1, comprising (E).

38. The system of claim 37, wherein said ultraviolet radiation from said ultraviolet radiation source comprises UV radiation having a wavelength in the vicinity of 365 nanometers.

39. The system of claim 37, wherein the ultraviolet radiation decomposition system is constructed and arranged to operate at temperature in a range of from about 15° C. to about 45° C.

40. The system of claim 37, wherein the ultraviolet radiation decomposition system is constructed and arranged to successively expose the effluent to differing wavelengths of ultraviolet radiation.

41. A method for abatement of effluent including one or more contaminants including fluorine-containing species, ammonia, or silane, the method comprising:
treating effluent in a main abatement tool;
discharging treated effluent from the main abatement tool to a polishing scrubber; and
treating discharged effluent with one or more additional compatible steps selected from the group consisting of the following:
(A) scrubbing a previously treated effluent comprising ammonia and one or more fluorine-containing species with an aqueous scrubbing medium, collecting the aqueous scrubbing medium in a collection volume thereof, and recirculating the aqueous scrubbing medium from the collection volume to the scrubbing step, with a residence time of the aqueous scrubbing medium in the collection volume being maintained to solubilize sufficient ammonia to form ammonium hydroxide in sufficient amount to substantially remove the fluorine-containing species from the effluent without formation of OF₂;
(B) recirculating an ancillary scrubbing medium in closed loop contacting of the previously treated effluent, to remove residual gases unabated by previous treatment and to destroy unwanted by-product fluorine-containing species in the scrubbed effluent;
(C) contacting the previously treated effluent with a dry scrubber medium effective for removing OF₂ from said treated effluent;
(D) contacting the previously treated effluent with a catalyst medium effective to catalytically enhance decomposition of OF₂ in contact therewith, to catalytically decompose and substantially remove OF₂ from the treated effluent; and
(E) exposing the previously treated effluent to ultraviolet radiation effective for decomposition of OF₂ in exposure thereto, to decompose and substantially remove OF₂ from the treated effluent.

42. The method of claim 41, comprising (A).

43. The method of claim 42, wherein the effluent derives from a silicon nitride semiconductor process tool including a plasma reactor constructed and arranged for combination of silane, ammonia and an oxidizing agent during silicon nitride deposition, and for subsequent chamber clean of the plasma reactor generating molecular fluorine and other fluorine-containing compounds as effluent components of the effluent.

44. The method of claim 42, wherein residence time of the aqueous scrubbing medium in the aqueous scrubbing medium collection volume is in a range of from about 0.25 to about 10 minutes during said silicon nitride deposition.

45. The method of claim 42, wherein residence time of the aqueous scrubbing medium in the aqueous scrubbing medium collection volume is sufficient to achieve a solubilization of ammonium hydroxide in a concentration range of from about _{—}0.001_grams per liter to about 30 grams per liter.

46. The method of claim 41, comprising (B).

47. The method of claim 46, wherein the ancillary scrubbing medium is recirculated through a packed bed of packing material facilitating gas/liquid contacting in said closed loop gas/liquid contacting.

48. The method of claim 47, wherein the packed bed has a void volume in the range of from about 30% to about 70%, based on the total volume of the bed.

49. The method of claim 47, wherein the packed bed has an average surface to volume ratio of the packing elements in a range of from about 10,000 cm⁻¹ to about 100,000 cm⁻¹.

50. The method of claim 47, wherein the bed comprises a fixed bed.

51. The method of claim 47, wherein the ancillary scrubbing medium comprises a reducing agent.

52. The method of claim 51, wherein the reducing agent comprises a reducing agent selected from the group consisting of sodium thiosulfate, ammonium thiosulfate, ammonium hydroxide, ammonium fluoride, and combinations of two or more thereof.

53. The method of claim 47, wherein the ancillary scrubbing medium comprises a liquid phase material capable of removing OF₂ from the scrubbed effluent.

54. The method of claim 47, wherein the ancillary scrubbing medium comprises an organic fluid capable of removing OF₂ from the scrubbed effluent.

55. The method of claim 47, wherein the ancillary scrubbing medium comprises a dissolved inorganic salt capable of removing OF₂ from the scrubbed effluent.

56. The method of claim 41, comprising (C).

57. The method of claim 56, wherein the dry scrubber medium comprises carbon.

58. The method of claim 57, wherein the carbon comprises activated carbon.

59. The method of claim 57, wherein the carbon is in a bead form.

60. The method of claim 57, wherein the carbon is in a honeycomb form.

61. The method of claim 56, further comprising heating the dry scrubber medium to elevated temperature.

62. The method of claim 56, wherein the dry scrubber medium comprises calcium hydroxide.

63. The method of claim 62, further comprising heating the dry scrubber medium to elevated temperature.

64. The method of claim 56, wherein the dry scrubber medium comprises a material reactive with OF₂ to abate same, selected from the group consisting of calcium hydroxide, copper hydroxide, sodium hydroxide, magnesium hydroxide, lithium hydroxide, potassium hydroxide, barium hydroxide and ammonium hydroxide.

65. The method of claim 56, wherein the dry scrubber medium comprises heated elemental metal reactive with fluorine-containing species in the effluent to abate same.

66. The method of claim 65, wherein the heated elemental metal comprises a metal selected from the group consisting of copper, aluminum and iron.

67. The method of claim 65, wherein the heated elemental metal comprises a metal disposed on a support.

68. The method of claim 65, wherein the heated elemental metal comprises a metal in divided form.

69. The method of claim 65, further comprising maintaining the heated elemental metal at a sufficient temperature for the elemental metal to react with fluorine in the effluent to form a corresponding metal fluoride.

70. The method of claim 41, comprising (D).

71. The method of claim 70, wherein the catalyst medium comprises a transition metal.

72. The method of claim 71, wherein the transition metal is supported on a support element.

73. The method of claim 72, wherein the support element comprises a honeycomb structure.

74. The method of claim 71, wherein the transition metal is in an elemental metal form.

75. The method of claim 70, further comprising heating the catalyst medium to an elevated temperature sufficient to effect catalytic decomposition of OF₂.

76. The method of claim 41, comprising (E).

77. The method of claim 76, wherein said ultraviolet radiation comprises UV radiation having a wavelength in the vicinity of 365 nanometers.

78. The method of claim 76, wherein the scrubbed effluent is exposed to ultraviolet radiation at temperature in a range of from about 15° C. to about 45° C.

79. The method of claim 76, wherein the scrubbed effluent is successively exposed to differing wavelengths of ultraviolet radiation.
